(19) United States
(12) Patent Application Publication
(10) Pub. No.: US 2025/0156446 A1
(43) Pub. Date: May 15, 2025

(54) LABELING ASSISTANCE SYSTEM, LABELING ASSISTANCE METHOD, AND LABELING ASSISTANCE PROGRAM

(71) Applicant: NEC Corporation, Minato-ku, Tokyo (JP)

(72) Inventors: Noritaka Yamashita, Tokyo (JP); Takuroh Kashima, Tokyo (JP); Norihito Oi, Tokyo (JP); Asako Fujii, Tokyo (JP)

(73) Assignee: NEC Corporation, Minato-ku, Tokyo (JP)

(21) Appl. No.: 18/836,438

(22) PCT Filed: Mar. 2, 2022
(86) PCT No.: PCT/JP2022/008750

§ 371 Date: Aug. 7, 2024

(51) Int. Cl. G06F 16/28

(52) U.S. Cl. CPC G06F 16/285

(57) ABSTRACT

The classification means 191 generates a plurality of clusters by classifying data to be labeled through unsupervised learning. The search means 192 searches for common points of the data included in each generated cluster. The output means 193 outputs information on the searched common points for each cluster.

### TECHNICAL FIELD

The present invention relates to a labeling assistance system, a labeling assistance method, and a labeling assistance program for assisting labeling for unlabeled data.

### BACKGROUND ART

In the IoT (Internet of Things) society, it has become possible to collect data from various devices. The classification of data is important for data searches and AI (Artificial Intelligence) learning conducted using the vast amount of collected data.

In this context, various methods for assisting data classification have been proposed. For example, Patent Literature 1 describes a sensor data classification device that classifies sensor data obtained from numerous sensors based on their characteristics. The device described in Patent Literature 1 associates the set of sensor data divided into pre-set time intervals with sensor identifiers and division interval identifiers and calculates multiple types of characteristic parameters from the data included in the divided data set.

### CITATION LIST

### Patent Literature

PL 1: Patent Publication No. 2016-99888

### SUMMARY OF INVENTION

### Technical Problem

For example, when data is classified into clusters based on extracted features, it is important to assign meaning to (to label) the clusters. However, labeling each piece of clustered data is a highly costly task, especially when there is a large amount of data in the clusters, making the impact significant.

Furthermore, for example, when the data to be classified is video data, it takes time to verify the data. Additionally, when the data to be classified includes multiple sensor data, determining which data to focus on becomes a complex task.

In the device described in Patent Literature 1, the method for calculating feature parameters for classification and the division intervals are predefined. However, even if data is classified based on values calculated according to some criteria, the cost problem remains in performing meaningful labeling work for unlabeled data.

Therefore, the purpose of the present invention is to provide a labeling assistance system, labeling assistance method, and labeling assistance program that can assist the labeling work for clusters of classified unlabeled data.

### Solution to Problem

The labeling assistance system according to the present invention includes a classification means for generating a plurality of clusters by classifying data to be labeled through unsupervised learning, a search means for searching for common points of the data included in each generated cluster, and an output means for outputting information on the searched common points for each cluster.

The labeling assistance method includes: generating a plurality of clusters by classifying data to be labeled through unsupervised learning, by a computer; searching for common points of the data included in each generated cluster, by the computer; and outputting information on the searched common points for each cluster, by the computer.

The labeling assistance program for causing a computer to execute: a classification process of generating a plurality of clusters by classifying data to be labeled through unsupervised learning; a search process of searching for common points of the data included in each generated cluster; and an output process of outputting information on the searched common points for each cluster.

### Advantageous Effects of Invention

According to the present invention, it is possible to assist labeling work for clusters of classified unlabeled data.

### BRIEF DESCRIPTION OF DRAWINGS

FIG. 1 It depicts a block diagram showing a configuration example of an example embodiment of the labeling assistance system according to the present invention.

FIG. 2 It depicts is an explanatory diagram showing an example of data used in the labeling assistance system.

FIG. 3 It depicts an explanatory diagram showing an example of features.

FIG. 4 It depicts an explanatory diagram showing an example of a graphical visualization of dimensionally reduced data.

FIG. 5 It depicts an explanatory diagram showing an example of the contribution of each sensor displayed in a graph.

FIG. 6 It depicts an explanatory diagram showing an example of the distribution of sensor values within a cluster.

FIG. 7 It depicts an explanatory diagram showing an example of statistical information within a cluster.

FIG. 8 It depicts a flowchart showing an operation example of the labeling assistance system according to the present invention.

FIG. 9 It depicts a block diagram showing an outline of the labeling assistance system according to the present invention.

FIG. 10 It depicts a schematic block diagram showing the configuration of a computer according to at least one example embodiment.

### DESCRIPTION OF EMBODIMENTS

Hereinafter, example embodiments of the present invention will be described with reference to the drawings. In the following description, video (video data) is exemplified as an example of unlabeled data. However, unlabeled data is not limited to videos, and may include, for example, still images, music data, text data, etc. Also, unlabeled data (data to be labeled) may be referred to as unclassified data hereinafter.

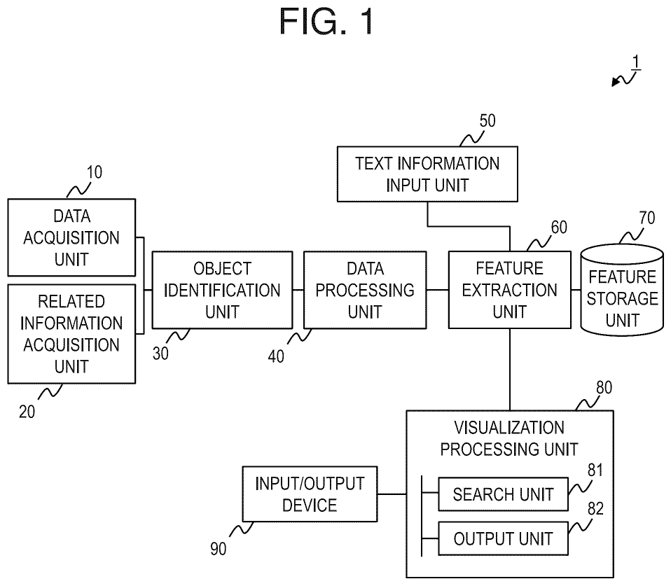

FIG. 1 is a block diagram showing a configuration example of an example embodiment of the labeling assistance system according to the present invention. The labeling assistance system 1 of this example embodiment includes a data acquisition unit 10, a related information acquisition unit 20, an object identification unit 30, a data processing unit 40, a text information input unit 50, a feature extraction unit 60, a feature storage unit 70, a visualization processing unit 80, and an input/output device 90.

The data acquisition unit 10 acquires data to be labeled (i.e., unclassified data). For example, when a vehicle being driven is imaged by a camera (not shown), the data acquisition unit 10 may acquire the video of the vehicle taken by the camera as the data to be labeled. Note that the data acquired by the data acquisition unit 10 is not limited to data acquired in real-time. The data acquisition unit 10 may, for example, acquire the data to be labeled from a storage server (not shown) where the data to be labeled is stored.

The related information acquisition unit 20 acquires information related to the data to be labeled (hereinafter referred to as related information). In this example embodiment, the related information is information indicating the situation in which the data to be labeled was generated, and includes, for example, information indicating the place where the data was generated (where the data was imaged) or the time, and data acquired by sensors (hereinafter referred to as sensor data).

For example, when the data to be labeled is video data imaged by an in-vehicle camera (drive recorder), the related information may include GPS (Global Positioning System) information indicating the vehicle position, and information acquired based on CAN (Controller Area Network). Examples of sensor data acquired in this case include speed, acceleration, position (latitude, longitude, altitude, etc.).

In addition, when video showing the operating status of a thermal power plant is used as the data to be labeled, sensor data such as fuel flow rate, pressure, temperature, rotation speed, power generation amount, etc., are mentioned. Other examples include when video showing the situation of a farm is used as the data to be labeled, sensor data such as time, temperature, humidity, pH, soil moisture content, solar radiation, wind direction and speed, water level, etc., are mentioned.

The object identification unit 30 identifies objects included in the acquired data and generates information (hereinafter referred to as an object list) specifying the identified objects. For example, when the object to be identified is a vehicle, the object identification unit 30 may identify the vehicle from the data acquired by the data acquisition unit 10 and generate information (e.g., coordinates indicating the position in the image, etc.) specifying the vehicle as an object list. The method for identifying objects from images or videos is widely known, and detailed descriptions are omitted here.

The data processing unit 40 processes the data (more specifically, the object list) into a form that can be used by the feature extraction unit 60 described later. Specifically, the data processing unit 40 processes the data to improve the accuracy of feature extraction and clustering. The data processing unit 40 may perform operations such as thinning the data, interpolating missing values, excluding outliers, and deleting unnecessary data items. For example, when the data to be labeled is video data, the data processing unit 40 may convert the video data into numerical time-series data.

The text information input unit 50 accepts input of text data containing information (hereinafter referred to as additional information) to be added to each data to be labeled. Additional information is information indicating the content of the data to be labeled that can be acquired in addition to the related information. Examples of categories indicating additional information include weather, plant types, and traffic participants. Examples of category values for weather include sunny, cloudy, rainy, snowy, etc., examples of category values for plant types include rice, wheat, barley, etc., and examples of traffic participants include automobiles, bicycles, pedestrians, etc.

Note that the input of text data is optional. In other words, additional information for the data to be labeled may not be input. However, it is preferable to input additional information because the more additional information is associated with the data to be labeled, the higher the classification accuracy can be improved. In the following description, data to be labeled associated with additional information will also be simply referred to as data to be labeled.

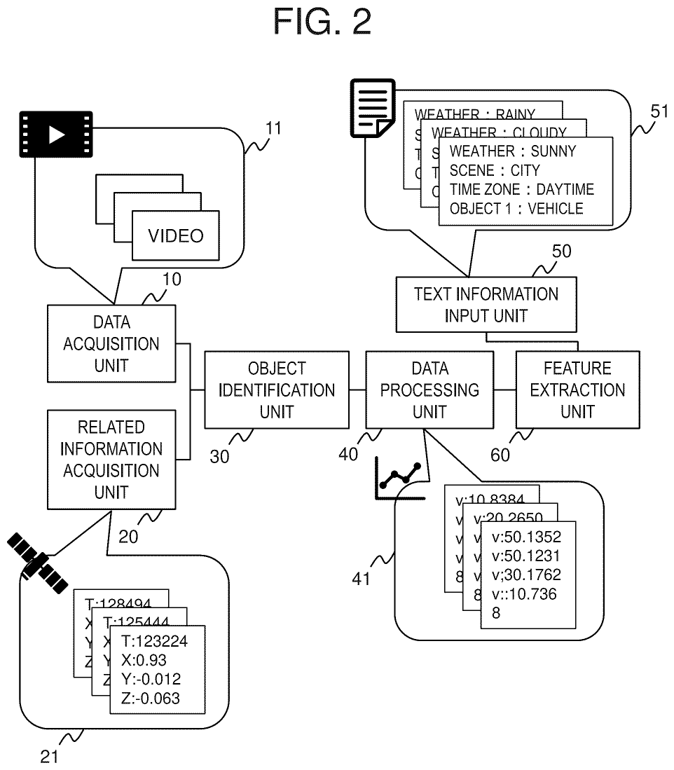

FIG. 2 is an explanatory diagram showing an example of data used in the labeling assistance system 1 of this example embodiment. In the example shown in FIG. 2, the data acquisition unit 10 acquires video 11 as the data to be labeled, and the related information acquisition unit 20 acquires related information 21 regarding the location where the video 11 was taken. In the example shown in FIG. 2, the data processing unit 40 processes the video 11 and related information 21 (more specifically, the object list generated by the object identification unit 30) and generates numerical time-series data 41. Furthermore, in the example shown in FIG. 2, the text information input unit 50 accepts input of text data 51 containing information regarding weather, scene, time zone, and objects as additional information.

The feature extraction unit 60 extracts features from each data to be labeled. The feature extraction unit 60 of this example embodiment generates multiple clusters by automatically classifying each piece of data to be labeled, which includes additional information, through unsupervised learning. The method for generating clusters through unsupervised learning is arbitrary, and examples include the k-means method and Gaussian mixture models.

Then, the feature extraction unit 60 extracts the features of each data included in the generated clusters. The feature extraction unit 60 may extract the additional information included in the text data as features. In addition, the feature extraction unit 60 may extract the features indicated by the numerical time-series data. Specifically, the feature extraction unit 60 may extract features based on the sensor values included in the data to be labeled (more specifically, the numerical time-series data).

The method of extracting features from numerical time-series data is arbitrary. For example, the feature extraction unit 60 may extract features such as the distance from the centroid of the numerical time-series data included in each cluster to each data point (cluster distance feature) in clusters generated by the k-means method.

In this way, since the feature extraction unit 60 performs the process of classifying the data to be labeled through unsupervised learning, it can also be referred to as a classification means. Furthermore, in this example embodiment, the object identification unit 30 identifies objects from the data acquired by the data acquisition unit 10 and the related information acquisition unit 20, and the data processing unit 40 processes the data into a form that can be used by the feature extraction unit 60. However, the data acquisition unit 10 may directly acquire data in a form that can be used by the feature extraction unit 60 and input the acquired data to the feature extraction unit 60. In this case, the labeling assistance system 1 may not include the related information acquisition unit 20, the object identification unit 30, and the data processing unit 40.

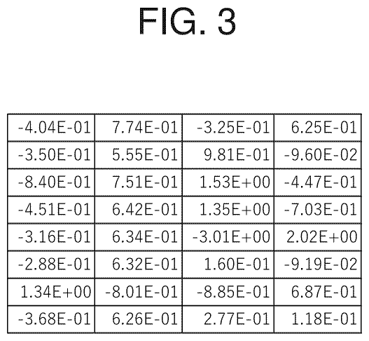

The feature storage unit 70 stores the features extracted by the feature extraction unit 60. The form in which the feature storage unit 70 stores the features for each data is arbitrary. FIG. 3 is an explanatory diagram showing an example of the features stored by the feature storage unit 70. In the example shown in FIG. 3, the vertical direction represents one feature point, and the horizontal direction represents the features (category values) of each category (e.g., weather, traffic participants, plant types, etc.). The feature storage unit 70 is realized by, for example, a magnetic disk, etc.

The visualization processing unit 80 performs processing to visualize information contributing to the labeling work for the generated clusters. The visualization processing unit 80 includes a search unit 81 and an output unit 82.

The search unit 81 searches for common points of the data to be labeled included in each generated cluster. Specifically, the search unit 81 extracts the features of each data included in the generated clusters and searches for the common points of the features of the extracted data. The search unit 81 may search for common points of category values in each extracted category as features or may search for common points of features extracted based on numerical time-series data.

For example, when focusing on the categories described above, the search unit 81 may identify a category value as a common point if the proportion of data within a cluster sharing that category value exceeds a predetermined threshold. Specifically, the proportion can be calculated based on the ratio of the number of data points with the common point to the total number of data points in the cluster. In this case, the search unit 81 may search for common points for the category values of all categories or for the category values of any arbitrary subset of categories.

Additionally, as a process for searching for common points, the search unit 81 may search for the most common category value (for example, in the case of numerical values, the most frequent value) for each category indicated by the data to be labeled as the common point. The search unit 81 may then identify the category value with the highest proportion as the common point.

Furthermore, when features are extracted based on sensor values indicated by numerical time-series data, the search unit 81 may calculate the contribution of the sensor values to the features. For example, if the relationship between the sensor values of the data to be labeled and the features is expressed in a linear form, the search unit 81 may consider the weight of the sensor values included in the linear form as the contribution and identify the sensor value with the highest weight as the common point.

The output unit 82 outputs information on the searched common points. The output unit 82 may output and display information on the common points searched for each cluster to the input/output device 90 or may output and store the information in a storage unit (not shown) provided in the labeling assistance system 1.

Specifically, the output unit 82 may output one common point with the highest degree of commonality among the searched common points. For example, if a category value is identified as a common point, the output unit 82 may output the name of the category and the category value (for example, “Weather: Sunny”). Additionally, if a sensor value is identified as a common point, the output unit 82 may output the sensor value and the name of the sensor that obtained the sensor value.

Moreover, if the contribution of the sensor values to the features is calculated, the output unit 82 may output the sensor value with the highest contribution as the common point, along with the sensor value and the name of the sensor.

Furthermore, the output unit 82 may output multiple candidates for common points searched within the cluster according to the degree of commonality of the common points. The output unit 82 may, for example, output the degree of commonality itself or may output the common points with the highest degree of commonality as labeling candidates in a ranking format up to a predetermined rank.

Additionally, the output unit 82 may directly label and output information indicating the searched common points for the unlabeled data (i.e., the data to be labeled) within each cluster. In this case, the output unit 82 may label and output information indicating the common point with the highest degree of commonality.

Moreover, the output unit 82 may visualize the data to be labeled by graphically drawing the reduced-dimension data (dimensional reduction) to be labeled on the input/output device 90, allowing humans to observe how the data to be labeled is clustered. The output unit 82 may, for example, reduce the dimensions of the data to be labeled to two or three dimensions by methods such as UMAP (Uniform Manifold Approximation and Projection) and visualize the reduced-dimension data as scatter plots or other graphs. At that time, the output unit 82 may display data classified into the same cluster in a different manner (e.g., changing colors, changing symbols, etc.) from other clusters.

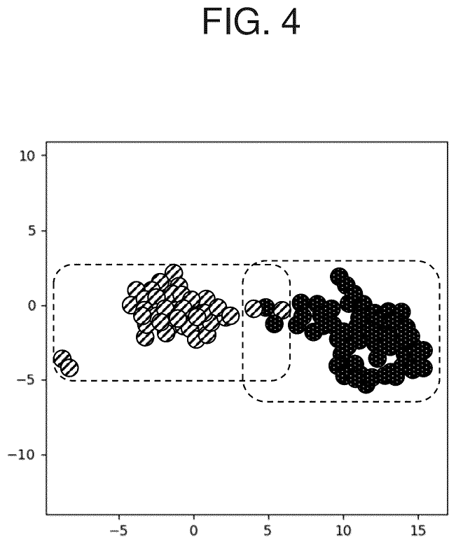

FIG. 4 is an explanatory diagram showing an example of a graphical visualization of dimensionally reduced data. The graph illustrated in FIG. 4 shows data reduced to two dimensions by UMAP and displayed with different patterns (e.g., diagonal lines, solid black, etc.) for each cluster. As illustrated in FIG. 4, the output unit 82 may display the range of data included in the clusters by enclosing the range to identify the clusters.

Furthermore, during graph drawing, the output unit 82 may display all the data or decide whether to display only data that meets specific conditions or not. The output unit 82 may, for example, decide whether to display clusters that meet specific conditions (e.g., clusters with a number of data points exceeding a predetermined threshold) or unclassified data (i.e., data that has not been labeled).

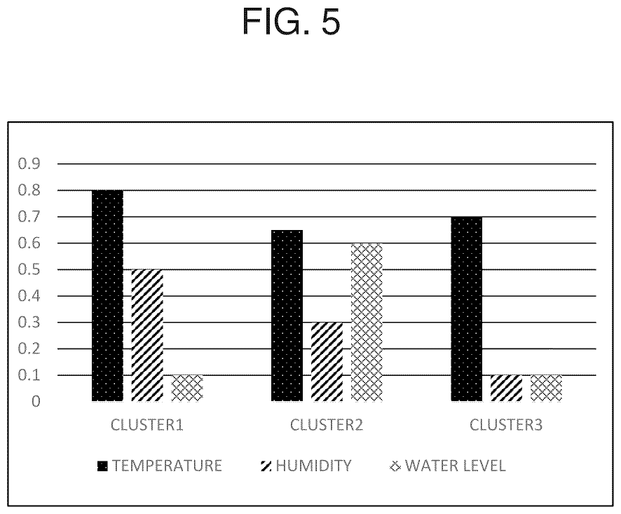

Furthermore, if the contribution of the sensor values to the features is calculated, the output unit 82 may graphically display the contribution of each sensor within the cluster. FIG. 5 is an explanatory diagram showing an example of the contribution of each sensor displayed in a graph. In the example shown in FIG. 5, the features of each cluster are calculated using sensor values indicating temperature, humidity, and water level, and the contribution of each sensor value used in calculating the features is displayed in a bar graph. For example, the features of cluster 2 indicate a high contribution of the sensor value indicating the water level compared to other clusters.

The display of the contribution of each sensor is not limited to the bar graph illustrated in FIG. 5 and may include grouped bar graphs, line graphs, 3D surface graphs, etc.

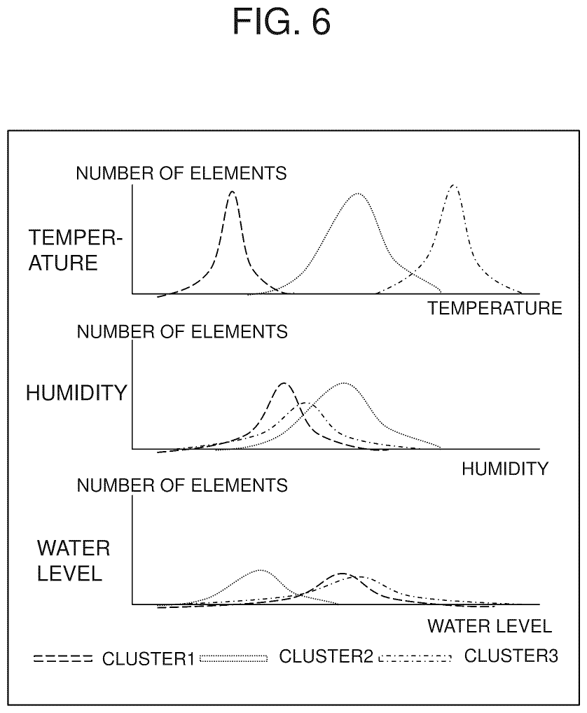

Additionally, the output unit 82 may output the distribution of sensor values within the cluster. FIG. 6 is an explanatory diagram showing an example of the distribution of sensor values within a cluster. In the example shown in FIG. 6, the data to be labeled includes sensor values for temperature, humidity, and water level, and as illustrated in FIG. 6, the distribution indicating the distribution is displayed for each sensor value. The vertical axis of the graph shown in FIG. 6 indicates the number of elements, and the horizontal axis indicates the sensor values. The display of the distribution of sensor values within the cluster is not limited to the distribution diagram illustrated in FIG. 6 and may include frequency distribution tables or histograms.

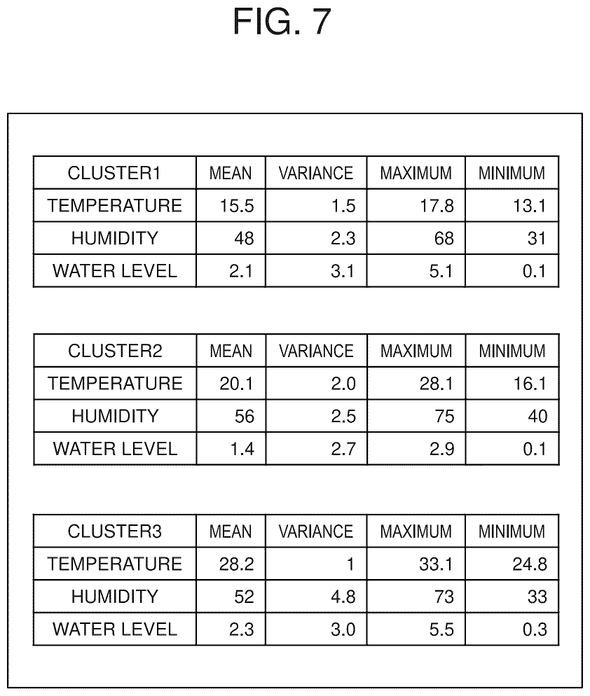

Furthermore, the output unit 82 may output statistical information within the cluster. FIG. 7 is an explanatory diagram showing an example of statistical information within a cluster. The statistical information illustrated in FIG. 7 includes the mean, variance, maximum, and minimum of each sensor value included in the data within the cluster, output for each cluster. The output statistical information is exemplary, and other statistical information such as the median or mode may also be output.

The input/output device 90 displays the output results of the output unit 82. The input/output device 90 also accepts input from the user regarding the displayed results and executes processing based on the input. For example, if the input/output device 90 accepts input specifying a cluster from the user, it may display detailed information on the specified cluster. Specifically, the input/output device 90 may display statistical information generated by the output unit 82 for the specified cluster.

The input/output device 90 may be realized by a tablet terminal, etc. In addition, the input/output device 90 may be realized by a device having a display device and a pointing device, etc.

For example, when the range of clusters is displayed as illustrated in FIG. 4, the input/output device 90 may accept input specifying the target cluster from the user and display information on the specified cluster (e.g., information illustrated in FIGS. 5, 6, and 7).

The data acquisition unit 10, the related information acquisition unit 20, the object identification unit 30, the data processing unit 40, the text information input unit 50, the feature extraction unit 60, and the visualization processing unit 80 (more specifically, the search unit 81 and the output unit 82) are realized by the processor (e.g., CPU (Central Processing Unit)) of a computer operating according to a program (labeling assistance program).

For example, the program is stored in a storage unit (not shown) of the labeling assistance system 1, and the processor may read the program and operate according to the program as the data acquisition unit 10, the related information acquisition unit 20, the object identification unit 30, the data processing unit 40, the text information input unit 50, the feature extraction unit 60, and the visualization processing unit 80 (more specifically, the search unit 81 and the output unit 82). Also, the functions of the labeling assistance system 1 may also be provided in the form of Saas (Software as a Service).

The data acquisition unit 10, the related information acquisition unit 20, the object identification unit 30, the data processing unit 40, the text information input unit 50, the feature extraction unit 60, and the visualization processing unit 80 (more specifically, the search unit 81 and the output unit 82) may be realized by dedicated hardware. Additionally, some or all components of each device may be realized by general-purpose or dedicated circuits, processors, etc., or combinations thereof. These may be configured by a single chip or by multiple chips connected via a bus. Some or all components of each device may be realized by a combination of the aforementioned circuits and programs.

Furthermore, when some or all components of the labeling assistance system 1 are realized by multiple information processing devices or circuits, the multiple information processing devices or circuits may be centrally located or distributed. For example, the information processing devices or circuits may be realized in a form connected via a communication network, such as a client-server system or a cloud computing system.

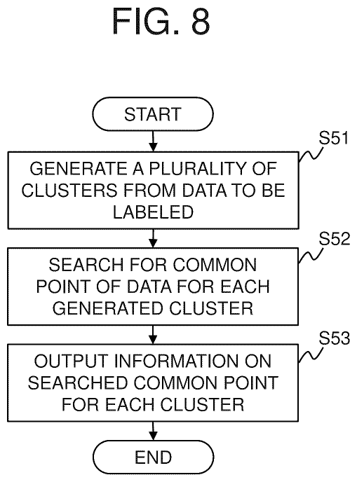

Next, the operation of the labeling assistance system 1 of this example embodiment will be described. FIG. 8 is a flowchart showing an operation example of the labeling assistance system 1. The operation example illustrated in FIG. 8 shows the case where the data acquisition unit 10 directly acquires data in a form used by the feature extraction unit 60 and inputs the acquired data to the feature extraction unit 60.

The feature extraction unit 60 generates a plurality of clusters from the data to be labeled (step S51). The search unit 81 searches for the common points of the data for each generated cluster (step S52). Then, the output unit 82 outputs information on the searched common points for each cluster (step S53).

As described above, in this example embodiment, the feature extraction unit 60 generates a plurality of clusters by classifying the data to be labeled through unsupervised learning, the search unit 81 searches for the common points of the data included in each generated cluster, and the output unit 82 outputs information on the searched common points for each cluster. With such a configuration, it is possible to assist the labeling work for clusters of classified unlabeled data.

Additionally, by having the output unit 82 automatically label the data to be labeled or output labeling candidates, the cost of labeling by humans is reduced, and humans can understand the reason why the label is applied.

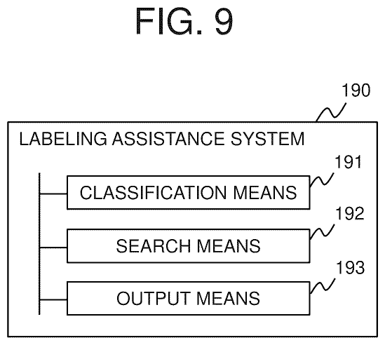

Next, the outline of the present invention will be described. FIG. 9 is a block diagram showing an outline of the labeling assistance system according to the present invention. The labeling assistance system 190 (e.g., the labeling assistance system 1) according to the present invention includes a classification means 191 (e.g., the feature extraction unit 60) for generating a plurality of clusters by classifying data to be labeled through unsupervised learning, a search means 192 (e.g., the feature extraction unit 60) for searching for common points of the data included in each generated cluster, and an output means 193 (e.g., the output unit 82) for outputting information on the searched common points for each cluster.

With such a configuration, it is possible to assist labeling work for clusters of classified unlabeled data.

Furthermore, the classification means 191 may extract features of each data included in the generated clusters, and the search means 192 may search for the common points of the features extracted for each data within the cluster.

Furthermore, the classification means 191 may extract features based on sensor values included in the data to be labeled, the search means 192 may calculate contribution of the sensor values to the features, and the output means 193 may output the sensor value with the highest contribution as a common point.

Furthermore, the output means 193 may graphically display the contribution of each sensor within the cluster.

Furthermore, the output means 193 may label and output information indicating the common point searched within each cluster for the data to be labeled.

Furthermore, the output means 193 may output multiple common points searched within the cluster according to the degree of commonality.

Furthermore, the output means 193 may output the common points with the highest degree of commonality as labeling candidates in a ranking format up to a predetermined rank.

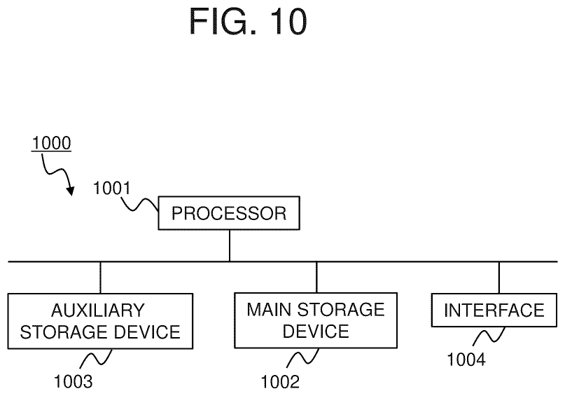

FIG. 10 is a schematic block diagram showing the configuration of a computer according to at least one example embodiment. The computer 1000 includes a processor 1001, a main memory 1002, an auxiliary memory 1003, and an interface 1004.

The labeling assistance system 190 described above is implemented in the computer 1000. The operations of each processing unit described above are stored in the auxiliary memory 1003 in the form of a program (labeling assistance program). The processor 1001 reads the program from the auxiliary memory 1003, expands it into the main memory 1002, and executes the above processing according to the program.

Note that the auxiliary memory 1003 in at least one example embodiment is an example of a non-transitory tangible medium. Other examples of non-transitory tangible media include magnetic disks, magneto-optical disks, CD-ROMs (Compact Disc Read-Only Memory), DVD-ROMs (Digital Versatile Disc Read-Only Memory), semiconductor memories, etc., connected via the interface 1004. Furthermore, when this program is delivered to the computer 1000 via a communication line, the computer 1000 may expand the delivered program into the main memory 1002 and execute the above processing.

Furthermore, this program may be intended to realize only part of the functions described above. Moreover, this program may be a so-called differential file (differential program) realized in combination with other programs already stored in the auxiliary memory 1003 that realize the functions described above.

A part of or all of the above example embodiments may also be described as, but not limited to, the following supplementary notes.
(Supplementary note 1) A labeling assistance system comprising:
   a classification means for generating a plurality of clusters by classifying data to be labeled through unsupervised learning;
   a search means for searching for common points of the data included in each generated cluster; and
   an output means for outputting information on the searched common points for each cluster.
(Supplementary note 2) The labeling assistance system according to Supplementary note 1, wherein
   the classification means extracts the features of each data included in the generated clusters, and
   the search means searches for the common points of the features extracted for each data within the cluster.
(Supplementary note 3) The labeling assistance system according to Supplementary note 1 or 2, wherein
   the classification means extracts features based on sensor values included in the data to be labeled,
   the search means calculates contribution of the sensor values to the features, and
   the output means outputs the sensor value with the highest contribution as a common point.
(Supplementary note 4) The labeling assistance system according to Supplementary note 3, wherein
   the output means graphically displays the contribution of each sensor within the cluster.
(Supplementary note 5) The labeling assistance system according to Supplementary note 1 or 2, wherein
   the output means labels and outputs information indicating the common point searched within each cluster for the data to be labeled.
(Supplementary note 6) The labeling assistance system according to any one of Supplementary notes 1 to 5, wherein
   the output means outputs multiple common points searched within the cluster according to the degree of commonality.
(Supplementary note 7) The labeling assistance system according to Supplementary note 6, wherein
   the output means outputs the common points with the highest degree of commonality as labeling candidates in a ranking format up to a predetermined rank.
(Supplementary note 8) A labeling assistance method comprising:
   generating a plurality of clusters by classifying data to be labeled through unsupervised learning, by a computer;
   searching for common points of the data included in each generated cluster, by the computer; and
   outputting information on the searched common points for each cluster, by the computer.
(Supplementary note 9) The labeling assistance method according to Supplementary note 8, wherein
   features of each data included in the generated clusters are extracted by the computer, and
   the common points of the features extracted for each data within the cluster are searched by the computer.
(Supplementary note 10) A program storage medium storing a labeling assistance program for causing a computer to execute:
   a classification process of generating a plurality of clusters by classifying data to be labeled through unsupervised learning;
   a search process of searching for common points of the data included in each generated cluster; and
   an output process of outputting information on the searched common points for each cluster.
(Supplementary note 11) The program storage medium according to Supplementary note 10, storing the labeling assistance program for causing a computer to:
   extract features of each data included in the generated clusters in the classification process; and
   search for common points of the features extracted for each data within the cluster in the search process.
(Supplementary note 12) A labeling assistance program for causing a computer to execute:
   a classification process of generating a plurality of clusters by classifying data to be labeled through unsupervised learning;
   a search process of searching for common points of the data included in each generated cluster; and
   an output process of outputting information on the searched common points for each cluster.
(Supplementary note 13) The program storage medium according to Supplementary note 12, storing the labeling assistance program for causing a computer to:
   extract features of each data included in the generated clusters in the classification process; and
   search for common points of the features extracted for each data within the cluster in the search process.

The above description of the present invention is with reference to the example embodiments, but the present invention is not limited to the above example embodiments. Various changes can be made to the composition and details of the present invention that can be understood by those skilled in the art within the scope of the present invention.

### REFERENCE SIGNS LIST

1 Labeling assistance system
10 Data acquisition unit
20 Related information acquisition unit
30 Object identification unit
40 Data processing unit
50 Text information input unit
60 Feature extraction unit
70 Feature storage unit
80 Visualization processing unit
81 Search unit
82 Output unit
90 Input/output device

What is claimed is:

1. A labeling assistance system comprising:
a memory storing instructions; and
one or more processors configured to execute the instructions to:
generate a plurality of clusters by classifying data to be labeled through unsupervised learning;
search for common points of the data included in each generated cluster; and
output information on the searched common points for each cluster.

2. The labeling assistance system according to claim 1, wherein the processor is configured to execute the instructions to:
extract features of each data included in the generated clusters; and
search for the common points of the features extracted for each data within the cluster.

3. The labeling assistance system according to claim 1, wherein the processor is configured to execute the instructions to:
extract features based on sensor values included in the data to be labeled;
calculate contribution of the sensor values to the features; and
output the sensor value with the highest contribution as a common point.

4. The labeling assistance system according to claim 3, wherein the processor is configured to execute the instructions to
display the contribution of each sensor within the cluster.

5. The labeling assistance system according to claim 1, wherein the processor is configured to execute the instructions to
label and output information indicating the common point searched within each cluster for the data to be labeled.

6. The labeling assistance system according to claim 1, wherein the processor is configured to execute the instructions to
output multiple common points searched within the cluster according to the degree of commonality.

7. The labeling assistance system according to claim 6, wherein the processor is configured to execute the instructions to
output the common points with the highest degree of commonality as labeling candidates in a ranking format up to a predetermined rank.

8. A labeling assistance method comprising:
generating a plurality of clusters by classifying data to be labeled through unsupervised learning, by a computer;
searching for common points of the data included in each generated cluster, by the computer; and
outputting information on the searched common points for each cluster, by the computer.

9. The labeling assistance method according to claim 8, wherein
features of each data included in the generated clusters are extracted by the computer, and
the common points of the features extracted for each data within the cluster are searched by the computer.

10. A non-transitory computer readable information recording medium storing a labeling assistance program, when executed by a processor, that performs a method for:
generating a plurality of clusters by classifying data to be labeled through unsupervised learning;
searching for common points of the data included in each generated cluster; and
outputting information on the searched common points for each cluster.

11. The non-transitory computer readable information recording medium according to claim 10, the labeling assistance program further performs a method for:
extracting features of each data included in the generated clusters in the classification process; and
searching for common points of the features extracted for each data within the cluster in the search process.
